(19) United States
(12) Patent Application Publication
(10) Pub. No.: US 2025/0291841 A1
(43) Pub. Date: Sep. 18, 2025

(54) Quality Management Data Analysis with Machine Learning Models

(71) Applicant: Rarebit Inc., Roslindale, MA (US)

(72) Inventor: Martin Olson, Milwaukee, WI (US)

(21) Appl. No.: 19/081,963

(22) Filed: Mar. 17, 2025

Related U.S. Application Data
(60) Provisional application No. 63/566,147, filed on Mar. 15, 2024.

(51) Int. Cl. G06F 16/583; G06F 5/01; G06F 16/54; G06N 20/00

(52) U.S. Cl. CPC G06F 16/583; G06F 5/01; G06F 16/54; G06N 20/00

(57) ABSTRACT

A system may receive, from a client device, a query requesting quality information of a target device. The system may access a set of data records associated with the target device, pre-process the set of data records for extracting raw data associated with the target device from the set of data records, and convert the pre-processed data to normalized data using a first large language model (LLM). The system may apply a second LLM to the normalized data for generating an output result, which includes the requested quality information of the target device. Applying the second LLM may include: retrieving contextual information related to the target device; generating a prompt to the second LLM, the prompt comprising at least the normalized data, the retrieved contextual information, and the query requesting quality information of the target device; and providing the generated prompt to the second LLM to receive the output result.

### CROSS-REFERENCE TO RELATED APPLICATIONS

This application claims priority to Provisional Patent Application No. 63,566,147, which was filed on Mar. 15, 2024, which is incorporated by reference.

### TECHNICAL FIELD

The disclosed configuration relates generally to quality management data analysis, and more particularly to quality management data analysis using machine learning models, for example in the medical field.

### BACKGROUND

Addressing quality problems with quality management systems (QMS) is relevant in many industries, e.g., medical devices, automobile, aerospace, or any regulated or manufacturing space that may involve a QMS. One example where quality issues commonly are raised through a variety of sources is the medical device and products area, where quality issues may be raised across many sources and formats. Utilization of all of the available sources of medical quality reporting poses significant challenges in data integration, scalability, and complexity of analysis. For example, some crucial information is contained in test results (e.g., tables of hundreds of thousands of numbers representing release testing results in excel files) and the “EM (Environmental Monitoring) Database” (entries in a SQL database and associated paper records). Integrating data from diverse sources, such as clinical trials, electronic health records, and manufacturing records, requires overcoming differences in formats, structures, and standards, ensuring that valuable insights are not lost in the process.

Additionally, as the volume of medical device data continues to expand rapidly, scalability becomes a critical concern, necessitating scalable infrastructure like cloud computing to handle large datasets efficiently. Large amounts of information necessary to understand and fix quality problems may be contained in “Batch Records.” The Batch Records are described as being 70,000 100-page pdfs (up to seven million pages) of production travelers for each product, component, and subcomponent produced at the facility, documenting every step along the way of production in tables of dense handwritten numbers and margin notes. Effectively addressing these challenges is essential for improving the safety, effectiveness, and reliability of medical devices and products. Similar types of issues also exist in the other industries mentioned above.

### SUMMARY

A system receives, from a client device, a query requesting quality information of a target device. The system may access a set of data records associated with the target device, pre-process the set of data records for extracting raw data associated with the target device from the set of data records, and convert the pre-processed data to normalized data using a first large language model (LLM). The system may apply a second LLM to the normalized data for generating an output result, which includes the requested quality information of the target device. When applying the second LLM, the system may retrieve contextual information related to the target device and generate a prompt to the second LLM. The generated prompt may include at least the normalized data, the retrieved contextual information, and the query requesting quality information of the target device. The system provides the generated prompt to the second LLM and receives the quality information of the target device as the output result.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

Figure (FIG. 1 is a high-level block diagram of a system environment for a data processing service, in accordance with one or more embodiments.

FIG. 2 illustrates one embodiment of exemplary modules of a computing system, in accordance with one or more embodiments.

FIG. 3 is a conceptual diagram of analyzing medical data using machine learning models, in accordance with one or more embodiments.

FIG. 4 illustrates an example user interface of a quality management data analysis system, in accordance with one or more embodiments.

FIG. 5 illustrates an example process for performing a quality management data analysis, in accordance with one or more embodiments.

FIG. 6 illustrates a structure of an example neural network is illustrated, in accordance with some embodiments.

FIG. 7 is an example machine to read and execute computer readable instructions, in accordance with an embodiment, in accordance with an embodiment.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium includes a computing system that analyzes quality data for evaluating products. The products can be those in industries such as medical, automobile, aerospace, maritime, nuclear, pharmaceutical, oil and gas, or any other regulated industry or industry involving manufacturing, or any area that involves a QMS for addressing quality control. Different industries may have their own QMS standards, such as, ISO 9001 and ISO 13458 standards from the International Organization for Standardization, IATF 16949 standard from the Automotive Quality Management system, AS9100 D standard from the International Aerospace Quality Group, etc. Specific requirements are tailored to unique regulatory environments for the specific industries. For instance, while medical device manufacturers must keep complaint records, industries like oil and gas may focus more on tracking nonconforming products rather than direct customer complaints. Sectors like aerospace and automotive do maintain complaint records, demonstrating how QMS standards evolve to meet industry-specific needs. The disclosed system can be used in an industry that involves QMS standards that must be met. These industries all have in common that there are certain events that must be tracked such as complaints by users about a product, or tracking a nonconforming product, or some other event that may violate a QMS standard. Disclosed here is a system of machine learning models that allow organizations in these QMS-focused areas to meet the standards.

Medical products are one example of such a QMS industry where there are many challenges in meeting the standards. In some cases, to meet the compliance requirements for medical devices, ISO 13485 outlines key elements such as document control, record control, complaint records, and customer communication requirements. Proper documentation management, maintaining auditable records, and handling customer complaints systematically help companies achieve consistency and accountability. Throughout this application, the example to illustrate the system is one that includes medical data for evaluating medical products, identifying quality issues, and provide quality prediction. However, the system and method are not limited to medical data but can include any data from any of the industries mentioned above. The system can include a series of machine learning models each trained to do different tasks in the quality analysis.

In the medical device space, regulatory standards require companies to properly document and investigate complaints regarding product safety. The regulations define the types of communications or statements by the medical device companies' customers that qualify as an actual “complaint.” For every “complaint” related to a medical device, the regulations require specific steps that the company take to address the issue, including reporting the complaint, having a formal investigation into the matter, possibly taking remediation actions, etc. Organizations must establish standardized procedures for communicating with customers, handling inquiries, and managing customer feedback while maintaining these records for a specified period.

However, due to the overwhelming volume of feedback, companies struggle to classify reports correctly. In one example, there can be tens of thousands of complaints a year for a device. These complaints may appear from many sources, in many different languages (e.g., French, Swedish, Mandarin, Polish, Russian, etc.), many different formats (e.g., pdf, Word document, email, text message, blog post, comment, etc.), in many record types (e.g., batch product records, environmental records, etc.), using many different forms, and reported using many different forums (e.g., website, email, text message, phone call, complaint form, etc.). Because of the large volume and many sources, languages, etc., communications that qualify as complaints may be missed regularly, resulting in major problems for the medical device company.

Misclassification of critical customer feedback or failure to recognize certain feedback as qualifying as a “complaint” may occur due to inefficient documentation and review processes. It is often difficult to even tell what is or is not a complaint, since a comment on a device could be considered a complaint according to the standards that must be met by medical device companies if it is presenting negative data, even though on its face it is not labeled or named as a complaint. For example, companies also get customer feedback that may include negative comments, but these are not formally submitted as complaints. Instead, these are informally written as comments or posts by users regarding a device. As another example, some customer feedback or other forms contain reports of hazardous product failures (e.g., a device catching fire or exploding), yet they might not be categorized as “complaints” due to mislabeling. The reviewer of those forms may not catch the issue or recognize that these should be labeled as complaints. Since these reports are marked as “customer feedback” rather than regulatory complaints, they often do not trigger an investigation and any other regulatory steps that are required, even though regulations require companies to treat such cases as complaints.

Historically, these records were stored in paper form, making it even harder to track patterns or identify urgent safety concerns. While electronic records are becoming more common, the challenge of sorting through massive amounts of data remains. This failure to properly classify and investigate feedback can lead to severe consequences, including delayed recalls and regulatory noncompliance.

In a medical data embodiment of a disclosed system, method and computer readable storage medium, there is a computing system that analyzes medical data for evaluating medical products, identifying quality issues, and provide quality prediction. The system scans batches of record data to transform the raw data to cleaned and structured machine-readable data. The system uses large language models (LLMs), which transform the machine-readable data into a predetermined canonical format, creating formatted data. The root causes of quality problems can be more easily identified. For instance, the LLMs may automatically analyze and classify customer feedback and determine whether a report qualifies as a regulatory complaint under international compliance standards. If the system identifies a potential safety issue, it flags the case for investigation and tracks whether similar issues are increasing or decreasing over time. This solution aligns with multiple regulatory frameworks, ensuring that companies remain compliant with ISO standards while improving safety monitoring. By automating the classification process, organizations may reduce the risk of missing serious safety concerns, improve regulatory compliance, and respond more efficiently to product defects. This ultimately enhances both customer safety and industry accountability by ensuring that no critical issue is overlooked due to a clerical misclassification.

In one aspect, the system described here captures all of this type of raw data that other systems may miss, and takes all data that is or could be considered complaints, from any or all sources, and in any or all languages, formats, forms, forums, etc., and essentially homogenizes it using machine learning models. The system processes and analyzes this data in a rapid manner, recognizing and processing complaints that a human would not detect, assessing in ways that a human cannot assess, and at a much faster pace than any human could.

In another aspect, the system may further input the formatted data into a customized series of large language model (LLM) for identify quality issues, analyzing root cause problems, and providing quality predictions. The customized LLM may be trained with historical medical data, such as, test result data and environmental monitoring data and regulatory policy and rules. The system conducts predictive analysis on the data to predict parts of a medical device that are more likely to have issues. The system makes a quality prediction on whether a particular batch of a medical device or other product is going to fail. By providing this analysis to the device maker, the device maker can determine whether to simply avoid sending out that batch predicted to fail to avoid quality complaints and save cost in having to recall or repair/replace the device once sent out and used in the field.

### System Overview

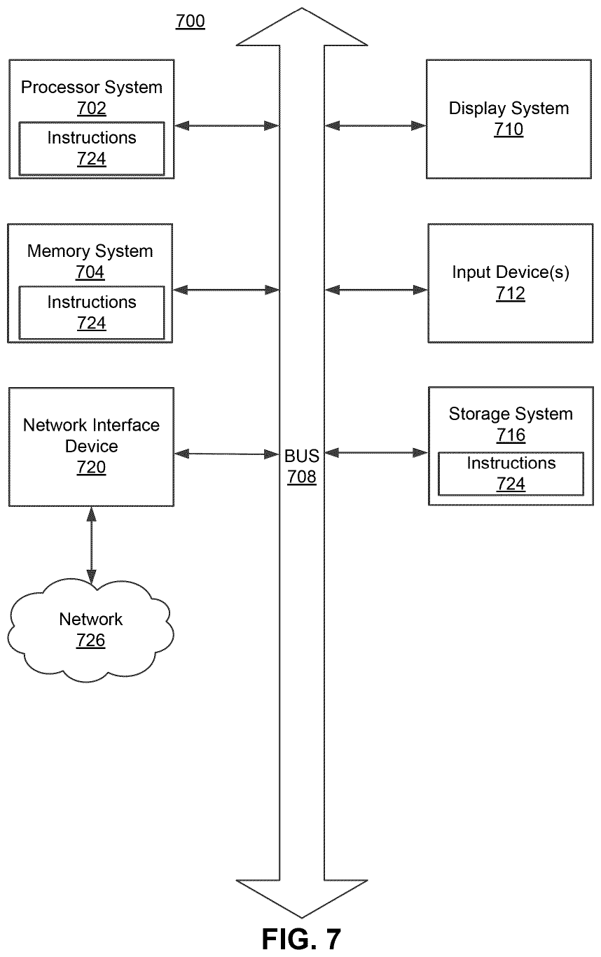

FIG. 1 is a high-level block diagram of a system environment 100 for a computing system 102, in accordance with one or more embodiments. The system environment 100 shown by FIG. 1 includes one or more client devices 106A, 106B, a network 120, a computing system 102, and a data storage system 104. In alternative configurations, different and/or additional components may be included in the system environment 100. The computing systems of the system environment 100 may include some or all of the components (systems (or subsystems)) of a computer system 700 as described with FIG. 7.

The computing system 102 analyzes quality data, such as medical data for evaluating medical products, identifying quality issues and providing a quality prediction. The computing system 102 may receive requests (e.g., data analysis, product report, etc.) from users of client devices 106 to perform one or more data processing functionalities on data stored, for example, in the data storage system 104. The requests may include query requests, analytics requests, or machine learning and artificial intelligence requests, and the like, on data stored by the data storage system 104. The computing system 102 may provide responses to the requests to the users of the client devices 106 after they have been processed.

The data storage system 104 includes a device (e.g., a disc drive, a hard drive, a semiconductor memory) used for storing database data (e.g., a stored data set, portion of a stored data set, data for executing a query). In one embodiment, the data storage system 104 includes a distributed storage system for storing data and may include a commercially provided distributed storage system service. Thus, the data storage system 104 may be managed by a separate entity than an entity that manages the computing system 102 or the data storage system 104 may be managed by the same entity that manages the computing system 102. In some embodiments, the data storage system 104 may store various types of information generated throughout the lifecycle of a medical device/product. In some embodiments, the data storage system 104 may store training datasets that are used to train one or more machine learning models, and or provide contextual information for large language models. In some embodiments, the data storage system 104 may store the intermediary data, such as raw data, machine-readable data, structured data that are generated during the analysis process. In some embodiments, the data storage system 104 may store the output result of the data analysis.

The client devices 106 are computing devices that display information to users and communicates user actions to the systems of the system environment 100. While two client devices 106A, 106B are illustrated in FIG. 1, in practice many client devices 106 may communicate with the systems of the system environment 100. In one embodiment, client devices 106 of the system environment 100 may include some or all of the components (systems (or subsystems)) of a computer system 700 as described with FIG. 7.

In one embodiment, a client device 106 executes an application allowing a user of the client device 106 to interact with the various systems of the system environment 100 of FIG. 1. For example, a client device 106 can execute a browser application to enable interaction between the client device 106 and the computing system 102 via the network 120. In another embodiment, the client device 106 interacts with the various systems of the system environment 100 through an application programming interface (API) running on a native operating system of the client device 106, such as IOS® or ANDROID™. The client device 106 may be any computing device. Example of such client device 106 may include a personal computer, a desktop, a laptop, a smart phone, a tablet, a wearable computing device such as a smart watch, an Internet-of-Things (IoT) device, and the like.

The network 120 includes any combination of local area and/or wide area networks, using wired and/or wireless communication systems. The network 120 may use standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 120 may be encrypted using any suitable technique or techniques.

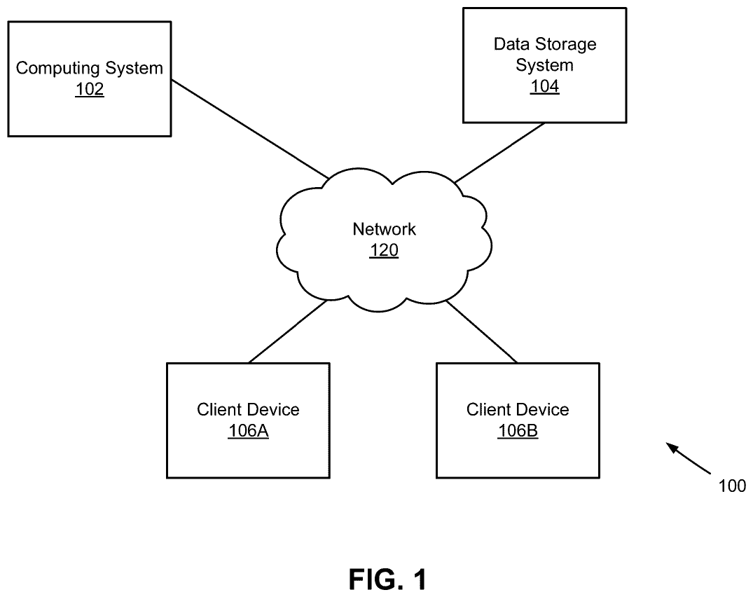

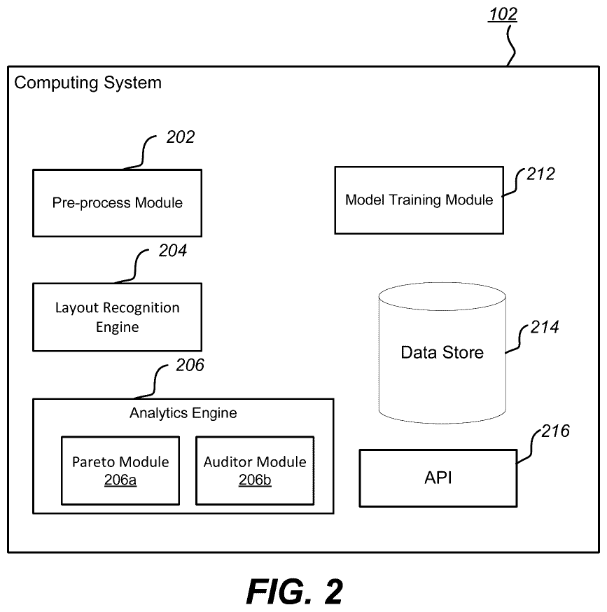

FIG. 2 illustrates one embodiment of exemplary modules of a computing system 102, in accordance with one or more embodiments. The computing system 102 includes a pre-process module 202, a layout recognition engine 204, an analytics engine 206, model training module 212, a data store 214, and an application program interface (API) 216. The modules depicted with respect to computing system 102 are exemplary; more or fewer modules, and databases may be used, consistent with the disclosure provided herein.

The pre-process module 202 extracts data from the data records. In some embodiments, the pre-process module 202 may use optical character recognition (OCR) to scan the data records to extract the raw data included in the data records. In some embodiments, the pre-process module 202 may use other text/language recognition tools, such as natural language process (NLP), pattern recognition, handwriting recognition, and the like, to identify the content included in the data records. In some embodiments, the pre-process module 202 may apply a machine-learned model, such as a large language model, to extract the raw data from the data records. The pre-process module 202 ingests large volumes of data records, e.g., customer feedback, complaints, etc. from various sources, such as emails, online reviews, support tickets, standardized complaint forms, and internal reports from quality assurance teams.

The layout recognition engine 204 converts extracted raw data into structured data. The structured data may be machine readable data with a predefined format so that the structured data may be input to subsequent data analysis tools for analysis. In some embodiments, the layout recognition engine 204 may apply a machine learning model that is trained on known data formats to transform the raw data into the machine-readable data, e.g., structured data. In some embodiments, the training data for that includes know data formats, regulatory compliance, etc., is stored in the data storage system 104 and/or the data store 214 of the computing system 102. In one implementation, the layout recognition engine 204 may apply the machine learning model to remove extraneous data from the transformed data. In another implementation, the layout recognition engine 204 may apply the machine learning model to annotate the batch record data. For example, the layout recognition engine 204 may ingest the transformed batch records and annotations separately into a relational database, such as, SQL (structured query language), a vector database for retrieval-augmented generation (RAG), and the like. In some embodiments, the layout recognition engine 204 may generate summarization of the input data records. In some embodiments, the layout recognition engine 204 may prepare the transformed data for subsequent analysis that utilizes machine learning models. In some embodiments, the layout recognition engine 204 may also generate metadata that describes the information of the transformed data/machine-readable data that is associated with the metadata.

The analytics engine 206 reads the structured data in the relational/SQL and/or vector databases to perform the requested analysis, and/or suggest actionable insights. In some embodiments, the analytics engine 206 may include a large language model (LLM). The computing system 102 may receive a user's input, such as a query and/or request. The analytics engine 206 may generate a prompt using the user input and the structured data, and provide the prompt to the LLM for execution. The analytics engine 206 may provide a set of pre-generated options for a user to create prompts to query the analytics engine 206. In some embodiments, the analytics engine 206 may automatically turn the prompt from single step to multistep prompt, e.g., breaking the user's request/query into multiple sub-requests/sub-queries so that the user may experience a more guided/informed query-response process, and so that even a nonexpert user can get the same kinds of outputs that an expert at prompt-writing for LLMs might get. Thus, the user's initial prompts are preprocessed by an LLM into multiple step-by-step prompts that act as a verifiable series of steps so that the user does not bias or contaminate the analysis in any way using the user's own language. This also allows a user or an administrator to double-check what the system did.

Using advanced NLP models, the layout recognition engine 204 may perform searches for specific terms related to severe injuries, fatalities, and hazardous device malfunctions. For example, keywords like “burned skin,” “electrocution,” “device exploded,” or “patient died” are flagged as potentially serious cases. Additionally, the layout recognition engine 204 aligns with regulatory frameworks to meet the compliance requirements with industry standards. By updating the machine learning models based on historical complaint datasets and continuously improving through supervised learning, the layout recognition engine 204 recognizes variations in how customers describe product failures so that even indirect mentions of critical issues are captured. Some regulators require strict complaint-handling procedures, including immediate reporting in cases of serious injury or death (often within 3-5 days). Delayed investigations or missing reports can lead to compliance failures and public health risks. The analytics engine 206 processes large datasets—such as 70,000 records—are processed, the analytics engine 206 may flag specific cases that may involve serious injury or death but were either misclassified as general feedback or not reported correctly. The analytics engine 206 may identify high-risk issues before regulatory authorities detect them during audits.

In some cases, if the complaints are incorrectly classified as general “customer feedback,” they may go unnoticed until an audit reveals the oversight, by which point, the company faces penalties or forced corrective actions. In some implementations, the analytics engine 206 continuously monitors feedback records and complaint logs to identify cases that may have been wrongly categorized. By leveraging pattern recognition algorithms, the analytics engine 206 compares flagged cases to past regulatory enforcement actions. If a serious complaint, such as a report of a product catching fire and burning a patient's skin, is mistakenly classified as general feedback instead of an adverse event, the analytics engine 206 may detect the discrepancy, alert the compliance team, and recommend reclassification for further investigation.

In some embodiments, when a potential complaint is identified, the analytics engine 206 verifies whether the correct reporting fields were completed. This validation step involves checking if the complaint was categorized correctly-whether as an adverse event, general feedback, or another classification. The analytics engine 206 may also verify that required fields, such as injury type, severity, and affected components, are properly filled out. If any necessary information is missing or incorrectly classified, the analytics engine 206 may automatically flag the record and notifies the compliance team. This prevents regulatory misclassification and ensures that urgent cases meet strict reporting deadlines, especially for serious incidents that must be reported within 3 to 5 days, depending on the specific regulations.

In some implementations, the analytics engine 206 may include a Pareto module 206a and an Auditor module 206b, seen in FIG. 2. These two modules may utilize LLMs, machine learning (ML) models and artificial intelligence (AI) technologies to identify misclassified complaints, detect regulatory reporting issues, and analyze trends in customer feedback data.

The Pareto module 206a may perform a Pareto analysis on the data records. A Pareto analysis is a decision-making technique used to identify the most significant factors contributing to a problem. The analytics engine 206 may analyze and identify trends in customer feedback and complaint data. For instance, if customer complaints about a specific defect rise from 1,000 to 5,000 within a month, this signals a major issue that must be reported under the corresponding regulations. The auditor module 206b operates at a more granular level, allowing users to drill down into individual complaints. While the Pareto module 206a highlights trends and potential problem areas, the auditor module 206b breaks down each complaint into key components, making it easier for quality engineers and compliance officers to investigate specific cases. For example, after the Pareto module 206a identifies a subset of electrical-related complaints within a dataset, the auditor module 206b may analyze the details of each flagged case to determine the root cause and whether regulatory reporting requirements were met.

In some embodiments, the computing system 102 combines locally hosted LLMs with retrieval augmented generation (RAG) to streamline compliance, analysis, and reporting. The computing system 102 may access a RAG-enabled database, which serves as a dynamic knowledge repository. The raw data and/or normalized data may be stored in the RAG database so that the computing system 102 may retrieve contextually relevant historical or regulatory precedents during analysis. Over time, the database grows richer, improving the accuracy and relevance of outputs across all downstream tasks. The computing system 102 uses RAG to enhance model outputs by integrating external, task-specific information retrieved from an underlying knowledge database (e.g., RAG database). When a user poses a query or provides input, the computing system 102 may first use RAG by retrieving relevant contextual data or information from external sources, such as company databases, documentation, or structured records. The computing system 102 incorporates that retrieved information into a prompt for an LLM. By augmenting the LLM's generative capabilities with precise external context, RAG significantly improves answer accuracy, consistency, and overall reliability, especially in specialized fields such as regulatory compliance, medical device quality assurance, and other industries where precise facts, policies, or detailed procedural knowledge must be accurately reflected.

In some embodiments, the computing system 102 uses multiple parallel LLM pipelines, each tailored for specific QMS objectives. For instance, one pipeline uses instruction-tuned LLMs to tag records with standardized keywords (e.g., “material defect” or “sterility breach”), enabling rapid Pareto analysis to pinpoint recurring issues. Simultaneously, a reasoning-focused pipeline assesses whether adverse events meet regulatory thresholds for reporting to agencies like the Food and Drug Administration (FDA). Other pipelines generate human-readable summaries for audit trails or analyze aggregated data to detect trends, such as seasonal spikes in manufacturing defects. New tasks, such as predictive risk modeling, are easily integrated by updating prompts, fine-tuning models, or connecting to external tools, ensuring the system evolves alongside regulatory and operational needs.

In some implementations, the computing system 102 employs two types of specialized LLMs: instruction-tuned models, optimized for structured tasks like classification, and reasoning-focused models, which handle complex decision-making requiring contextual nuance. These models may operate entirely on-premises, ensuring adherence to stringent data privacy regulations such as Health Insurance Portability and Accountability Act (HIPAA) and General Data Protection Regulation (GDPR). Unlike conversational models designed primarily for open-ended dialogue and interactive exchanges, reasoning and instruction LLMs are specialized and optimized toward structured, task-oriented processes. Conversational models excel at naturalistic, user-facing language generation but lack the consistency, operational precision, and logical rigor required for highly specialized tasks such as compliance analysis or systematic data processing. In contrast, instruction and reasoning LLMs provide accurate, repeatable, structured outputs needed for mission-critical applications related to medical device quality management and regulatory compliance.

In one embodiment, reasoning-focused LLMs may specialize in processing complex information and performing logical analysis, inference, or classification based on nuanced context and criteria. These models excel in tasks requiring nuanced understanding, logical decision-making, multi-step problem solving, or regulatory assessment, such as analyzing medical device data for adverse events or regulatory compliance. While all LLMs employ some level of reasoning ability, dedicated reasoning LLMs focus particularly on structured and context-intensive computational tasks, prioritizing accuracy and consistency of inferences over general language fluency.

Instruction-tuned LLMs, by contrast, are specialized to follow specific directives and reliably carry out clearly-defined tasks described in detailed prompts. They are trained or updated explicitly to respond precisely and predictably to instructions, enabling structured operations such as data normalization, tagging, classification, summarization, and report-writing workflows. Because these models have specialized prompts embedded into their usage, they achieve consistent and accurate performance ideal for repetitive, operationally-defined tasks within enterprise workflows.

In some embodiments, multiple specialized LLMs may work sequentially or collaboratively to enhance accuracy and comprehensiveness of outputs. In one example, when processing complaint records, an instruction-tuned LLM first normalizes and structures incoming raw text, tagging entries by predefined categories and extracting relevant keywords for effective indexing and future retrieval. Subsequently, a reasoning-oriented LLM assesses the normalized records to determine whether an adverse patient outcome occurred, evaluates the severity, and identifies if regulatory reporting obligations are triggered. Finally, another specialized LLM might take these structured and evaluated records to automatically generate human-readable reports or concise summaries, clearly communicating key findings and recommended actions to relevant stakeholders. By combining different LLMs within a single processing pipeline, tasks can be completed accurately and efficiently, with each model performing the role at which it is most capable, ultimately leading to improved decision-making quality and better regulatory compliance. In one example, the computing system 102 may apply one or more LLMs to the raw data and/or normalized data. Each of the one or more LLMs may include a different function that identifies quality information of the target device, e.g., a high-risk issue, reporting deadline, misclassification, etc. The computing system 102 receives a result from each of the one or more LLMs, and combines the results from the one or more LLMs to generate at least a portion of the requested quality information of the target device.

By unifying a centralized RAG database with modular, task-specific LLMs, the computing system 102 achieves both efficiency and adaptability. It reduces manual effort in data normalization, accelerates root-cause analysis, and ensures consistency in regulatory judgments, all while maintaining the security and traceability required for medical device compliance. As QMS requirements grow increasingly complex, this architecture provides a scalable framework to turn fragmented production data into actionable quality insights.

The model training module 212 may update an LLM model with contextual information and large amounts of real usage data. Updating the LLM model with contextual information allows the model to specialize in specific tasks or domains by updating their parameters to better align with the nuances and conventions of the medical products/devices. In some embodiments, updating the LLM model may include using retrieval augmented generation (RAG), which augments a natural language processing (NLP) model by connecting it to an organization's proprietary database. In some embodiments, updating the LLM model may include using supervised machine learning. In some embodiments, updating the LLM model may include fine-tuning the LLM which optimizes deep learning models for domain-specific tasks by training them on specialized datasets. The model training module 212 may apply an iterative process to train the LLM model whereby the model training module 212 updates parameter values of machine-learning models based on each of the set of training examples. The training examples may be processed together, individually, or in batches. The model training module 212 applies the LLM model to the input data in a training example to generate an output based on a current set of parameter values. The model training module 212 scores the output from the LLM model using a loss function. A loss function is a function that generates a score for the output of the machine-learning model such that the score is higher when the machine-learning model performs poorly and lower when the machine-learning model performs well. For example, the updating may include defining the specific objective, e.g., classification, regression, or another task, along with a loss function to optimize. The updating process may include iteratively training the LLM model on the training data using the chosen loss function and optimization algorithm, while monitoring performance on the validation set to prevent overfitting. Some example loss functions include the mean square error function, the mean absolute error, hinge loss function, and the cross-entropy loss function. The model training module 212 updates the set of parameters for the machine-learning model based on the score generated by the loss function. For example, the model training module 212 may apply gradient descent to update the set of parameters.

In some implementations, updating the LLM model may include updating a training dataset of the LLM model with new data records. The new data records may include recently generated/accessed data records related to a medical device/product. In some embodiments, updating the LLM model may include retrieving contextual information related to the medical device/product. The computing system 102 may update the LLM model using the updated training dataset and the retrieved contextual information. In some embodiments, real usage data further enriches the updating process by providing valuable insights into how the model interacts with users and responds to real-world scenarios. By incorporating this data, the model can adapt and improve its performance based on actual user behavior and preferences, resulting in more accurate and contextually relevant outputs. Updating LLMs with contextual information and real usage data enhances their ability to generate coherent and contextually appropriate responses.

The data store 214 may be configured to store the ML models, the LLM models, and/or the output result of the data records. In some embodiments, the data store 214 may include a RAG database. The data store 214 may collect, organize, and manage data for retrieval, updates, and analysis. In some embodiments, the data store 214 may be a component of the computing system 102. In some embodiments, the data store 214 may communicate with the data storage system 104 via the network 120. The data store 214 may be designed to ensure data confidentiality, integrity, and accessibility while adhering to strict privacy, compliance and regulation policies.

In some embodiments, the computing system 102 may provide an API 216, a software interface that provides functions and tools for users to input/upload data records, perform analysis on the data records, receive output results and notifications, view graphical representations of the output result, and the like. In some cases, the API 216 may provide a user interface at the client device 106.

### Quality Data Analysis

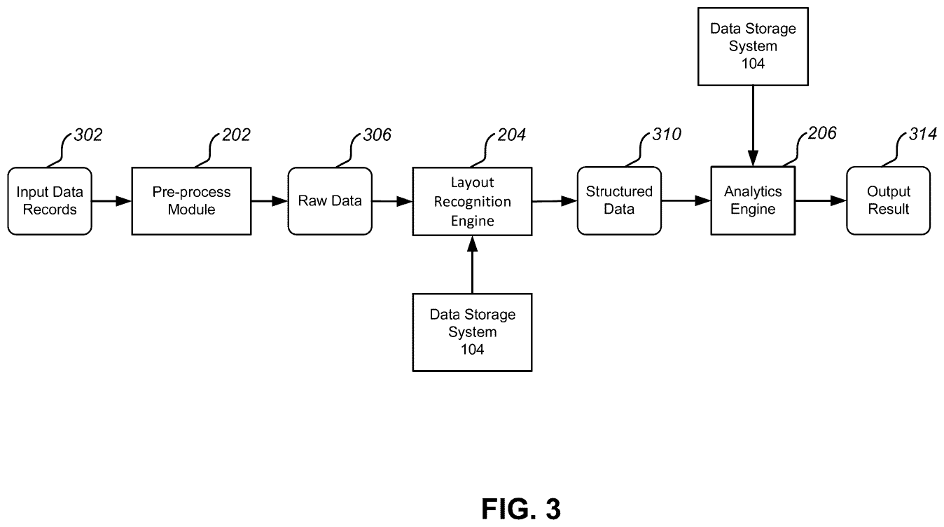

FIG. 3 is a conceptual diagram of analyzing quality data using machine learning models, in accordance with one or more embodiments. In various embodiments, the process includes different or additional steps than those described in conjunction with FIG. 3. Further, in some embodiments, the steps of the process may be performed in different orders than the order described in conjunction with FIG. 3. The process described in conjunction with FIG. 3 may be carried out by the computing system 102 in various embodiments. The process of FIG. 3 is described in relation to analyzing of medical data using machine learning models as one example of quality data that may be analyzed, though the process may work in generally the same manner in other industries.

As shown in FIG. 3, the computing system 102 may access a set of input data records 302. The computing system 102 may access the input data records 302 upon a request from a user. In some embodiments, the computing system 102 may access the input data records 302 from data storage system 104. In some embodiments, the computing system 102 may receive the input data records 302 from a client device 106. In some embodiments, the input data records 302 may include batches of data records. The input data records 302 may include various types of information generated throughout the lifecycle of a medical device/product. For example, the input data records 302 may include manufacture data that is collected during the manufacturing process, such as production records, quality control tests, and inspection reports, etc. The input data records 302 may also include clinical trial data that is generated from clinical trials conducted to evaluate the safety and efficacy of medical devices/products. In some embodiments, the input data records 302 may include user feedback and complains from users, e.g., healthcare provides. In some embodiments, the input data records 302 may include regulatory compliance data, for example, submissions to regulatory agencies, approvals, compliances, etc., with quality management standards. Various types of data that are generated and utilized in the context of medical devices/products may be received by the computing system 102 as the input data records 302 for analysis.

The pre-process module 202 in the computing system 102 may extract data from the input data records 302. In some embodiments, the pre-process module 202 may use optical character recognition (OCR) to scan the input data records 302 to extract the raw data 306. In one instance, the OCR provided by the pre-process module 202 may be customized with ML models to adapt to the features of the input data records 302. For instance, some of the input data records 302 may include cursive handwriting, and the OCR provided by the input data records 302 may be tailored for medical device records to recognize cursive handwriting. In some embodiments, the pre-process module 202 may use other text/language recognition tools to identify the content included in the input data records 302. The tools used by the pre-process module 202 may include but not limit to: NLP for structured analysis, instruction-based LLMs, reasoning-based LLMs, knowledge graphs, semantic search, OCR, computer vision, table recognition, document layout recognition, etc. For different record types, such as complaint records, customer feedback, or production records, etc., the pre-process module 202 apply different tools. For example, for handwritten production records, the pre-process module 202 may emphasize OCR and computer vision, while for customer feedback analysis, the pre-process module 202 may rely more on NLP and semantic search.

The layout recognition engine 204 receives the raw data 306 and converts the raw data 306 into structured data 310. The structured data 310 may be machine readable data with a predefined format so that the structured data 310 may be input to subsequent data analysis tools for analysis. The analytics engine 206 reads the structured data 310 to perform requested analysis. For instance, the analytics engine 206 may perform the requested analysis, and/or suggest actionable insights in the relational/SQL and/or vector databases. In some embodiments, the analytics engine 206 may include a large language model (LLM). In some implementation, the computing system 102 may receive a user's input, such as a query and/or request. The analytics engine 206 may generate a prompt using the user input and the structured data 310, and provide the prompt to the LLM for execution. In some embodiments, the analytics engine 206 may access the data storage system 104 to provide a context for the prompt. provide a set of pre-generated options for a user to create prompts to query the analytics engine 206.

In some implementations, after providing the prompt to the LLM model, the analytics engine 206 may use the LLM model to segment the structured data 310, with the segmentation based on the main instruction that follows the LLM's context size. In some examples, the main instruction may eliminate segments that are not related to the prompt. The LLM may further segment the remaining segments into smaller datasets. In some examples, the LLM may iteratively segment the datasets and remove irrelevant data until only data entries that are relevant remain for further analysis. The analytics engine 206 may apply the LLM to the final segmented dataset with the prompt and generate an output result 314 to present to the user. The output result 314 may include a quality evaluation, root cause analysis, quality prediction, trend prediction, and the like. In some embodiments, the output results may be in various formats, such as dashboard, report, buttons in a chat interface, etc. The user may use the output result 314 immediately or as a stepping point for subsequent prompts. In some examples, the user may compare one set of data (e.g., newly-scanned and transformed data) to prior data by using the LLM implemented by the analytics engine 206, and receive an output result 314 that predicts a product is likely to have quality issue or not. In some embodiments, the LLM model may be trained by using a training dataset that includes historical data with known quality issues. The output of the machine learning model may be a score that indicates a likelihood of a target product having a quality issue/meeting a regulatory compliance.

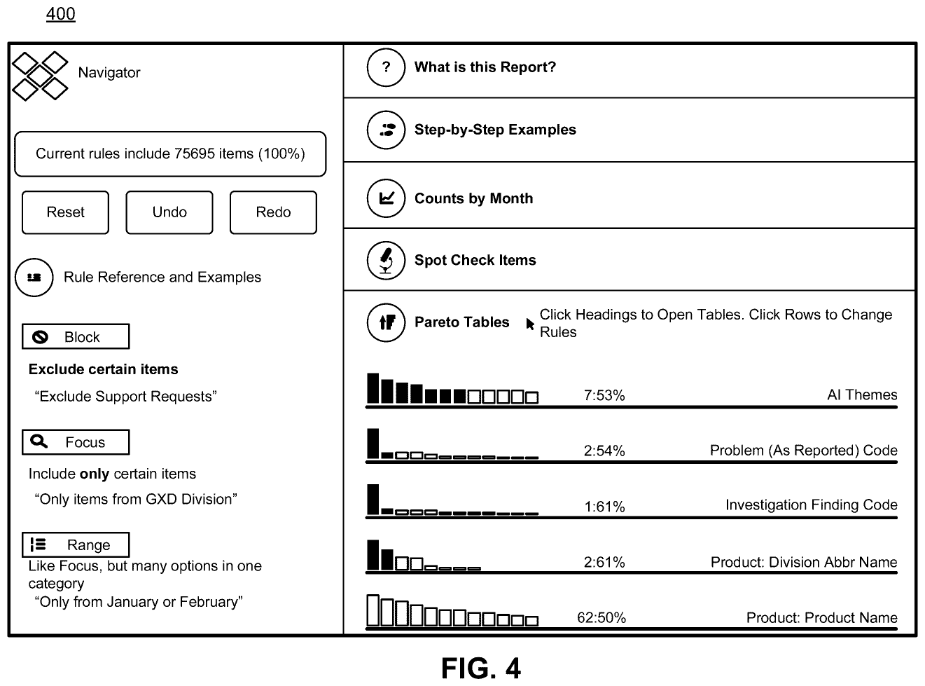

FIG. 4 illustrates an example user interface 400 of a quality management data analysis system, in accordance with one or more embodiments. The user interface may be a user interface provided by the API 216 of the computing system 102. The user interface may be displayed by a client device 106. In some embodiments, the example user interface may be displayed by a webpage browser, a mobile application, etc.

As shown in FIG. 4, the user interface 400 may include various user interface elements, and one or more user interface elements may be interactable for receiving user input and/or selections. In some embodiments, the user interface 400 may present the output result in a pre-defined formats and/or functions. In some embodiments, the formats and functions of the user interface may be customized. For example, for executives, the user interface 400 may have a dashboard that shows live status of complaints so executives can review and digest complaints as they appear and run analysis on the complaints; for chemists, the user interface may show live reports and canned buttons that chemists can select and use in a lab environment; and for regulators, the user interface may show predetermined reports in a regulatory format required for the regulators. The user interface 400 may include a visual element that identifies trends and highlights potential issues, illustrates patterns in complaints and feedback, and/or display information in a way that highlights priority areas for improvement. As shown in FIG. 4, the user interface 400 may display the data analysis results in graphs, such as bar charts, illustrating the identified trends. In some implementations, the user interface 400 may display predictions and/or output from one or more machine learning models. For example, the user interface 400 in FIG. 4 includes a user interface element “AI Themes,” displaying problems that are identified/predicted by the ML models, and have not been aware of by the corresponding manufacturers.

### Process of Quality Management Data Analysis

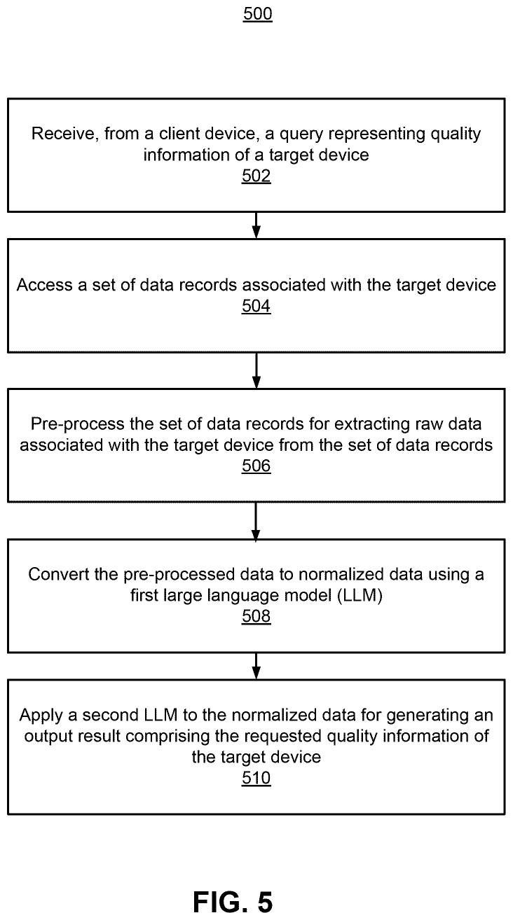

FIG. 5 illustrates an example process 500 for performing a quality management data analysis, in accordance with one or more embodiments. In various embodiments, the process includes different or additional steps than those described in conjunction with FIG. 5. Further, in some embodiments, the steps of the process may be performed in different orders than the order described in conjunction with FIG. 5. The process described in conjunction with FIG. 5 may be carried out by the computing system 102 in various embodiments. The process of FIG. 5 is described in relation to analyzing of medical data using machine learning models as one example of quality data that may be analyzed, though the process may work in generally the same manner in other industries. For example, the steps refer to a target device as an example, and the target device could be a medical device, or an automobile or component of an automobile, an airplane or aerospace vehicle, or component of such, machinery or components in the oil and gas industry, etc. The target device can thus be various types of products or components, and the method can be performed in relation to other regulated events including those that do not involve a target device.

As shown in FIG. 5, the computing system 102 may receive 502 a query requesting quality information of a target device from a client device 106. The computing system 102 may access 504 a set of data records associated with the target device. The computing system 102 may pre-process 506 the set of data records for extracting raw data associated with the target device from the set of data records. The computing system 102 may convert 508 the pre-processed data to normalized data using a first large language model (LLM). The computing system 102 applies 510 a second LLM to the normalized data for generating an output result. The output result may include the requested quality information of the target device.

In some embodiments, when applying the second LLM, the computing system 102 may retrieve contextual information related to the target device and generate a prompt to the second LLM. The prompt may include at least the normalized data, the retrieved contextual information, and the query requesting quality information of the target device. The computing system 102 provides the generated prompt to the second LLM and receives the requested quality information of the target device as the output result.

In some implementations, the second LLM may be obtained by fine-tuning an LLM model. Fine-tuning the LLM model may include: updating a training dataset of the second LLM with new data records comprising the quality information of the target device, retrieving contextual information related to the target device, and fine-tuning the second LLM with the updated training dataset and the retrieved contextual information.

The computing system 102 may transmit the requested quality information of the target device to the client device 106. In some embodiments, the computing system 102 may display the output result in a user interface. In some implementations, the computing system 102 may determine whether output quality information of the target device is associated with at least a threshold condition, e.g., high-risk issues, reporting deadline, undesired trend, and the like. If the output quality information is associated with a threshold condition, the computing system 102 may flag the issue, for example, sending a notification to the user by displaying the notification in a graphical user interface of the client device 106 and the notification may specify the type, details, level of risk and the like.

### Example Machine Learning Models

As explained above, there may be a system of machine learning models that have different functions that together operate to identify events such as complains that need to be addressed amongst a company's records and communications. In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN), long short-term memory networks (LSTM), transformers, linear recurrent neural networks such as Mamba may also be used. For example, various data normalization performed by layout recognition engine 204, quality related issue identification performed by analytics engine 206 and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to identify quality relate issues, the training samples may include manufacture data, such as production records, quality control tests, and inspection reports, etc.; clinical trial data, user feedback and complains from users, e.g., healthcare provides, and regulatory compliance data, for example, submissions to regulatory agencies, approvals, compliances, etc., with quality management standards. The labels for each training sample may be binary or multi-class. In training a machine learning model for identifying quality related issues, the training labels may also be multi-class with keywords such as “burn,” “explode,” “died,” etc.

By way of example, the training set may include multiple past records with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in identifying quality related issues, the objective function may correspond to correctly identifying potential issues from data records. In various embodiments, the error rate may be measured as cross-entropy loss, L1 loss (e.g., the sum of absolute differences between the predicted values and the actual value), L2 loss (e.g., the sum of squared distances).

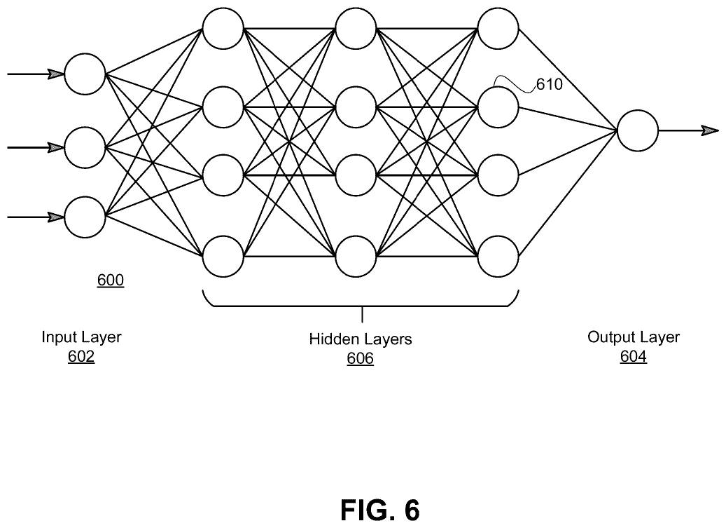

Referring to FIG. 6, a structure of an example neural network is illustrated, in accordance with some embodiments. The neural network 600 may receive an input and generate an output. The input may be the feature vector of a training sample in the training process and the feature vector of an actual case when the neural network is making an inference. The output may be the prediction, classification, or another determination performed by the neural network. The neural network 600 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 600 may vary in different embodiments. In various embodiments, a neural network 600 includes one or more layers 602, 604, and 606, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 610, kernels and/or coefficients. Training of a neural network, such as the NN 600, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 610. For example, a computing device may receive a training set that includes customer complaints and customer feedbacks. Each training sample in the training set may be assigned with labels indicating a quality related issue, such as “burn,” “death,” “explosion,” etc. The computing device, in a forward propagation, may use the machine learning model to generate predicted issue. The computing device may compare the predicted issue with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing issue identification or another suitable task for which the model is trained.

In various embodiments, the training samples described above may be refined and continue to re-train the model, which the model's ability to perform the inference tasks. In some embodiments, this training and re-training processes may repeat, which results in a computer system that continues to improve its functionality through the use-retraining cycle. For example, after the model is trained, multiple rounds of re-training may be performed. The process may include periodically retraining the machine learning model. The periodic retraining may include obtaining an additional set of training data, such as through other sources, by usage of users, and by using the trained machine learning model to generate additional samples. The additional set of training data and later retraining may be based on updated data describing updated parameters in training samples. The process may also include applying the additional set of training data to the machine learning model and adjusting parameters of the machine learning model based on the applying of the additional set of training data to the machine learning model. The additional set of training data may include any features and/or characteristics that are mentioned above.

Turning now to FIG. 7, illustrated is an example machine to read and execute computer readable instructions, in accordance with an embodiment. Specifically, FIG. 7 shows a diagrammatic representation of the computing system 102 (and/or data processing system) in the example form of a computer system 700. The computer system 700 is structured and configured to operate through one or more other systems (or subsystems) as described herein. The computer system 700 can be used to execute instructions 724 (e.g., program code or software) for causing the machine (or some or all of the components thereof) to perform any one or more of the methodologies (or processes) described herein. In executing the instructions, the computer system 700 operates in a specific manner as per the functionality described. The computer system 700 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 700 may be a server computer, a client computer, a personal computer (PC), a tablet PC, a smartphone, an internet of things (IoT) appliance, a network router, switch or bridge, or other machine capable of executing instructions 724 (sequential or otherwise) that enable actions as set forth by the instructions 724. Further, while only a single machine is illustrated, the term “machine” shall also be taken to include any collection of machines that individually or jointly execute instructions 724 to perform any one or more of the methodologies discussed herein.

The example computer system 700 includes a processing system 702. The processor system 702 includes one or more processors. The processor system 702 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 702 executes an operating system for the computing system 700. The computer system 700 also includes a memory system 704. The memory system 704 may include or more memories (e.g., dynamic random access memory (RAM), static RAM, cache memory). The computer system 700 may include a storage system 716 that includes one or more machine readable storage devices (e.g., magnetic disk drive, optical disk drive, solid state memory disk drive).

The storage unit 716 stores instructions 724 (e.g., software) embodying any one or more of the methodologies or functions described herein. The instructions 724 may also reside, completely or at least partially, within the memory system 704 or within the processing system 702 (e.g., within a processor cache memory) during execution thereof by the computer system 700, the main memory 704 and the processor system 702 also constituting machine-readable media. The instructions 724 may be transmitted or received over a network 726, such as the network 726, via the network interface device 720.

The storage system 716 should be taken to include a single medium or multiple media (e.g., a centralized or distributed database, or associated caches and servers communicatively coupled through the network interface device 720) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 700 can include a display system 710. The display system 710 may driver firmware (or code) to enable rendering on one or more visual devices, e.g., drive a plasma display panel (PDP), a liquid crystal display (LCD), or a projector. The computer system 700 also may include one or more input/output systems 712. The input/output (IO) systems 712 may include input devices (e.g., a keyboard, mouse (or trackpad), a pen (or stylus), microphone) or output devices (e.g., a speaker). The computer system 700 also may include a network interface device 720. The network interface device 720 may include one or more network devices that are configured to communicate with an external network 726. The external network 726 may be a wired (e.g., ethernet) or wireless (e.g., WiFi, BLUETOOTH, near field communication (NFC).

The processor system 702, the memory system 704, the storage system 716, the display system 710, the IO systems 712, and the network interface system 720 are communicatively coupled via a computing bus 708.

### Additional Considerations

The foregoing description of the embodiments of the disclosed subject matter have been presented for the purpose of illustration; it is not intended to be exhaustive or to limit the disclosed embodiments to the precise forms disclosed. Persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

What is claimed is:

1. A method, comprising:
receiving, from a client device, a query requesting quality information of a target device;
accessing a set of data records associated with the target device;
pre-processing the set of data records for extracting raw data associated with the target device from the set of data records;
converting the pre-processed data to normalized data using a first large language model (LLM); and
applying a second LLM to the normalized data for generating an output result comprising the requested quality information of the target device, wherein the applying the second LLM comprises:
retrieving contextual information related to the target device;
generating a prompt to the second LLM, the prompt comprising at least the normalized data, the retrieved contextual information, and the query requesting quality information of the target device; and
providing the generated prompt to the second LLM to receive the requested quality information of the target device as the output result.

2. The method of claim 1, wherein pre-processing the set of data records for extracting raw data associated with the target device from the set of data records comprises:
applying an optical character recognition (OCR) to scan the set of data records; and
extracting the raw data based on a result of the OCR scanning.

3. The method of claim 1, further comprising updating the second LLM by:
updating a training dataset of the second LLM with new data records comprising the quality information of the target device; and
fine-tuning the second LLM with the updated training dataset.

4. The method of claim 1, wherein the output result identifies a misclassification of a quality issue from the set of data records associated with the target device.

5. The method of claim 1, wherein the output result identifies a trend of a quality issue associated with the target device.

6. The method of claim 1, further comprising:
applying one or more additional LLMs to the normalized data, each of the one or more additional LLMs comprising a different function that identifies quality information of the target device;
receiving a result from each of the one or more additional LLMs; and
combining the results from the one or more additional LLMs to generate at least a portion of the requested quality information of the target device.

7. The method of claim 1, further comprising:
displaying, via a user interface displayed at the client device, a notification comprising the requested quality information of the target device.

8. A non-transitory computer readable storage medium comprising stored program code, the program code comprising instructions, the instructions when executed cause a processor system to:
receive, from a client device, a query requesting quality information of a target device;
access a set of data records associated with the target device;
pre-process the set of data records for extracting raw data associated with the target device from the set of data records;
convert the pre-processed data to normalized data using a first large language model (LLM); and
apply a second LLM to the normalized data for generating an output result comprising the requested quality information of the target device, wherein the instructions to apply the second LLM, when executed further cause the processor system to:
retrieve contextual information related to the target device;
generate a prompt to the second LLM, the prompt comprising at least the normalized data, the retrieved contextual information, and the query requesting quality information of the target device; and
provide the generated prompt to the second LLM to receive the requested quality information of the target device as the output result.

9. The non-transitory computer readable storage medium of claim 8, wherein the instructions to pre-process the set of data records for extracting raw data associated with the target device from the set of data records, when executed further cause the processor system to:
apply an optical character recognition (OCR) to scan the set of data records; and
extract the raw data based on a result of the OCR scanning.

10. The non-transitory computer readable storage medium of claim 8, wherein the instructions, when executed further cause the processor system to:
update the second LLM by:
updating a training dataset of the second LLM with new data records comprising the quality information of the target device; and
fine-tuning the second LLM with the updated training dataset.

11. The non-transitory computer readable storage medium of claim 8, wherein the output result identifies a misclassification of a quality issue from the set of data records associated with the target device.

12. The non-transitory computer readable storage medium of claim 8, wherein the output result identifies a trend of a quality issue associated with the target device.

13. The non-transitory computer readable storage medium of claim 8, wherein the instructions, when executed further cause the processor system to:
apply one or more additional LLMs to the normalized data, each of the one or more additional LLMs comprising a different function that identifies quality information of the target device;
receive a result from each of the one or more additional LLMs; and
combine the results from the one or more additional LLMs to generate at least a portion of the requested quality information of the target device.

14. The non-transitory computer readable storage medium of claim 8, wherein the instructions, when executed further cause the processor system to:
display, via a user interface displayed at the client device, a notification comprising the requested quality information of the target device.

15. A system comprising:
one or more computer processors; and
one or more computer-readable mediums comprising stored instructions that, when executed by the one or more computer processors, cause the system to:
receive, from a client device, a query requesting quality information of a target device;
access a set of data records associated with the target device;
pre-process the set of data records for extracting raw data associated with the target device from the set of data records;
convert the pre-processed data to normalized data using a first large language model (LLM); and
apply a second LLM to the normalized data for generating an output result comprising the requested quality information of the target device, wherein the instructions to apply the second LLM, when executed further cause the system to:
retrieve contextual information related to the target device;
generate a prompt to the second LLM, the prompt comprising at least the normalized data, the retrieved contextual information, and the query requesting quality information of the target device; and
provide the generated prompt to the second LLM to receive the requested quality information of the target device as the output result.

16. The system of claim 15, wherein the instructions to pre-process the set of data records for extracting raw data associated with the target device from the set of data records, when executed further cause the system to:
apply an optical character recognition (OCR) to scan the set of data records; and
extract the raw data based on a result of the OCR scanning.

17. The system of claim 15, wherein the instructions, when executed further cause the system to:
update the second LLM by:
updating a training dataset of the second LLM with new data records comprising the quality information of the target device; and
fine-tuning the second LLM with the updated training dataset.

18. The system of claim 15, wherein the output result identifies a misclassification of a quality issue from the set of data records associated with the target device.

19. The system of claim 15, wherein the output result identifies a trend of a quality issue associated with the target device.

20. The system of claim 15, wherein the instructions, when executed further cause the system to:
apply one or more additional LLMs to the normalized data, each of the one or more additional LLMs comprising a different function that identifies quality information of the target device;
receive a result from each of the one or more additional LLMs; and
combine the results from the one or more additional LLMs to generate at least a portion of the requested quality information of the target device.
